(19) United States
(12) Patent Application Publication
(10) Pub. No.: US 2011/0104048 A1
(43) Pub. Date: May 5, 2011

(54) HYDROGEN-GENERATING COLLOIDAL SUSPENSION

(75) Inventor: Marc Maury, Saint Medard En Jalles (FR)

(73) Assignee: UNITHER DEVELOPPEMENT, Amiens (FR)

(21) Appl. No.: 13/000,956

(22) PCT Filed: Jun. 23, 2009
(86) PCT No.: PCT/FR2009/051200

§ 371 Date: Dec. 22, 2010

(30) Foreign Application Priority Data
Jun. 25, 2008 (FR) 08 54233

(51) Int. Cl. C01B 3/08; C01B 3/02; B01J 19/00

(52) U.S. Cl. 423/657; 423/648.1; 422/129

(57) ABSTRACT

Described is the use of a colloidal suspension that includes between 2 and 60% of alkaline metal particles that are suspended in a neutral hydrophobic diluent for producing gaseous hydrogen, as well as a process for producing hydrogen. Also described is a hydrogen-generating device and its use.

This invention relates to the use of a particular composition for producing gaseous hydrogen.

The invention also relates to a hydrogen-generating device starting from this composition and its use for supplying a fuel cell.

The reduction of hydrocarbon stocks and the pollution problems of cities make necessary the development of new energies that are more available and less polluting than petroleum products.

One of the many paths explored for this purpose is the use of a fuel cell that makes it possible to produce electricity from hydrogen and oxygen.

Hydrogen is actually a vector fuel for energy per se; when it combusts with the oxygen of the air, it releases significant energy, producing only water.

However, the use as hydrogen fuel has always been confronted with problems of production and storage before its use, in particular for the on-board applications, which until now prevented large-scale development of this energy vector.

The storage of hydrogen is a problem that is technically difficult to solve.

The most compact storage in liquid form requires a cryogenic cooling at very low temperature and the design of reservoirs that are suitable for use in motor vehicles with extremely advanced insulation.

In addition, it is difficult to envision storing liquid hydrogen in a small quantity over long periods. Currently, the best reservoir prototypes make it possible to store the hydrogen for a period that is less than 1 month, because beyond that, the losses of hydrogen are enormous.

Hydrogen can also be stored in gaseous form. Nevertheless, taking into account the low molar mass of hydrogen, the storage in compressed form makes it possible to store only a small quantity of hydrogen, and because of the small size of the hydrogen molecules, leaks systemically appear by porosity. The extended and secure storage of hydrogen in gaseous form is therefore very limited.

It is also known that it is possible to store hydrogen in structures that absorb it in a reversible way. This storage method, which uses materials that have a more or less high affinity with hydrogen, makes possible a good storage capacity but always requires the manipulation of liquid or gaseous hydrogen. Furthermore, these storage systems in hydride form require the installation of a heating system to make possible the desorption of hydrogen.

There is therefore currently no suitable system for storing hydrogen. Another difficulty that slows the development of the hydrogen as an energy vector is its difficulty in being obtained.

The prior art describes several methods for the production of hydrogen, such as, in particular, the production by electrolysis of water, the production by reaction of water vapor that is superheated on carbon, hydrocarbon cracking, reforming of alcohol such as methanol or ethanol, or else the production by reaction of water on alkaline metals or borohydrides.

However, these methods for producing hydrogen require complex installations and an important energy source, which makes the production of hydrogen by the known methods difficult to integrate in a portable device.

The different constraints that are associated with storage and with the production of hydrogen therefore currently prevent large-scale development of this energy source.

There is thus still a need for a secure and high-performing system that makes it possible to use hydrogen, suitable for mobile applications.

This is the purpose of this invention that proposes to use a composition that can generate hydrogen by chemical reaction only when its use is necessary, without there being a need to store it.

In particular, the purpose of the invention is a composition that is designed for the production of hydrogen that comes in the form of a colloidal suspension that comprises between 2 and 60% of alkaline metal particles that are suspended in a neutral hydrophobic diluent.

The invention also covers a process for the production of hydrogen from this composition. Its purpose is also a device for producing hydrogen that comprises this composition and the use of this device for any application that requires hydrogen, for example for supplying a fuel cell or a thermal combustion engine.

“Colloidal suspension” is defined as any more or less viscous liquid composition that contains small particles in suspension.

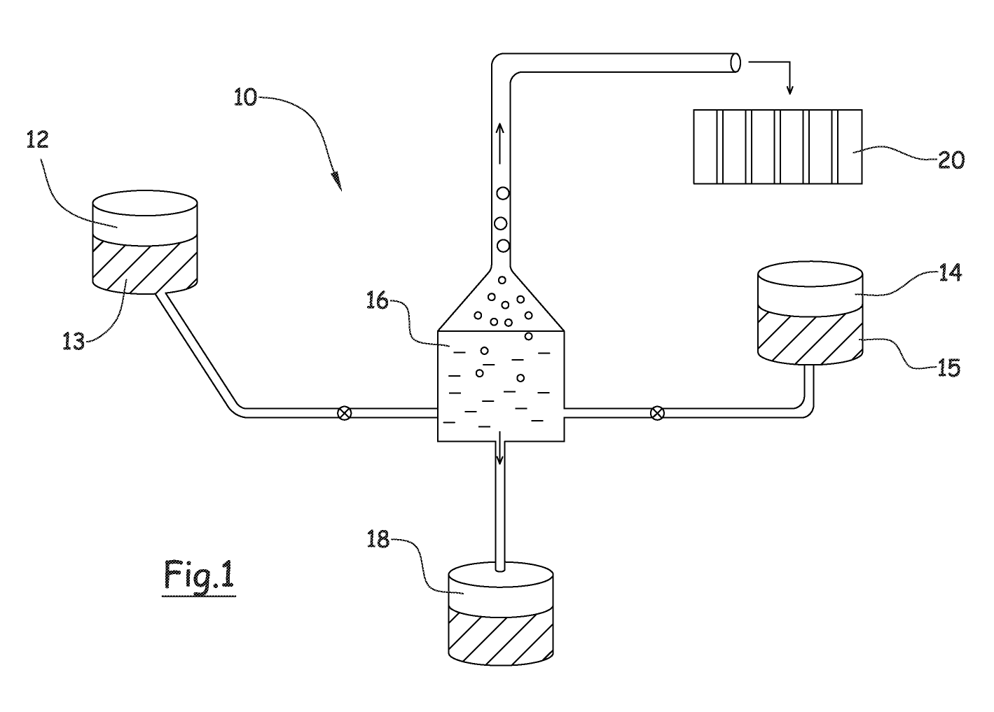

The invention is now described in detail with regard to the accompanying drawings in which FIG. 1 shows the diagram of a hydrogen production device according to the invention.

The composition that is intended for the production of hydrogen according to the invention comprises between 2 and 60% of alkaline metal particles that are suspended in a neutral hydrophobic diluent. This proportion of alkaline metal particles in the colloidal suspension is particularly suitable for the production of gaseous hydrogen. Preferably, even more suitably, the concentration of alkaline metal is between 5 and 40%.

The alkaline metal can be selected in particular from among sodium or lithium. Preferably, the suspension according to the invention comprises metallic sodium particles.

The alkaline metal comes in the form of particles of very small size, even nanoparticulate. According to a particularly suitable embodiment, the size of the particles is less than 15 μm. Preferably, it is between 0.1 and 1 μm.

These particles are suspended in a neutral hydrophobic diluent, such as an organic polymer that is selected from among vegetable oils and mineral oils. Preferably, the alkaline metal particles are suspended in a silicone oil.

According to one embodiment, the composition also comprises a dehydrating agent that makes it possible to tolerate in the suspension the presence of water in a small quantity or a trace of atmospheric moisture that can trigger premature reactions. Such a dehydrating agent is typically a composition that comprises mineral compounds in suspension such as phosphorus silica or phosphorus pentoxide, or else complex organic compounds such as zeolites.

The composition according to the invention can be obtained by, for example, the implementation of a process that comprises the following stages:
Heating sodium to a temperature that is higher than 97.5° C., preferably between 120 and 150° C., to obtain a liquid sodium solution that has this temperature,
Heating a hydrophobic diluent to an equivalent temperature that is higher than 97.5° C., preferably between 120 and 150° C., to obtain an oily solution that has this temperature,
Introducing, while being stirred, the liquid sodium solution into the oily solution,
Producing an emulsification using a colloidal grinder-type stirring turbine,
Injecting, under high pressure, the emulsion into a cooling system or a cold hydrophobic oily solution so as to recover the colloidal sodium particles.

Advantageously, the presence of the hydrophobic diluent makes it possible for the suspension to be kept in the liquid state without taking special precautions under the ambient storage conditions. The hydrophobic nature of the diluent protects the composition from accidental point contact with water, which would cause undesirable chemical reactions.

According to another advantage, the composition can be easily manipulated, is slightly viscous, and is stable at ambient temperature and pressure. It thus is possible to manipulate it easily and to store it in liquid form at ambient pressure.

The composition according to the invention is useful for producing hydrogen.

By bringing the colloidal suspension of the alkaline metal according to the invention into close contact with an aqueous solution, the water, preferably purified and demineralized, gradually reacts with the alkaline metal and generates gaseous hydrogen and an aqueous alkaline hydroxide emulsion, for example a sodium hydroxide solution.

The reaction that occurs is as follows:

2M+2H₂O→H₂+2M⁺2HO⁻

whereby M is an alkaline metal, preferably sodium or lithium.

The hydrophobic nature of the colloidal suspension according to the invention and its being brought into the presence of natural water limits the reaction speed of the reaction and therefore the risk of accidents by explosion.

To facilitate the reaction and the contact between the colloidal sodium and water, it is possible to introduce into the aqueous solution at least one emulsifying surfactant and/or an organic solvent. The surfactant and/or the organic solvent make possible an emulsification of oil and thus facilitate the reaction for producing hydrogen.

The surfactant can be selected from among suitable ionic or anionic surfactants. It can be, for example, a sorbitan ester, a polyoxyethylene, a polysorbate, or else a lecithin.

Preferably, the surfactant content is between 0.05 and 10%.

The composition according to the invention can be used in a simple hydrogen-generating device in which the reagents can be stored without low-temperature or high-pressure thermal limitation.

FIG. 1 shows a hydrogen-generating device 10 that comprises in particular:
A reservoir 12 for storing a composition 13 that comprises alkaline metal particles that are suspended in a neutral hydrophobic diluent,
A reservoir 14 for storing an aqueous solution 15,
A mixing chamber 16 into which the composition 13 and the aqueous solution 15 are introduced and from which the gaseous hydrogen 17 can escape. The mixing chamber 16, or reactor, can be made of stainless steel that is resistant to corrosion and to heat and may have a high-strength inner ceramic wall.

The composition 13 and the aqueous solution 15 are preferably injected under pressure into the chamber 16 using injection systems, thus avoiding any sealing problem.

The time management of the reaction in the mixing chamber 16 can be ensured by sensor devices and self-regulated injectors that allow the mixing.

According to a particularly suitable embodiment, the device 10 also comprises a reservoir 18 for recovery of hydrophobic oil and the aqueous alkaline hydroxide emulsion that are produced after reaction in the chamber 16. This reservoir 18 preferably consists of polymer material or inert composite material that is resistant to chemical attacks at very high pH.

The chamber 16 can also comprise a system for intake and grinding of sodium hydroxide crystals that are generated by the hydrogen-producing reaction.

This device is a complete portable system that makes possible the supply of a fuel cell that can be used in, for example, an electric vehicle. Actually, the hydrogen that is produced in the chamber 16 can be used to supply a fuel cell 20 with gaseous hydrogen to produce electricity with oxygen.

The device according to the invention can also be used to supply with gaseous hydrogen a low- or high-power thermal motor, or a stationary or mobile station for distribution of hydrogen, providing hydrogen upon demand and having its own independent power supply, in an ecological manner. Advantageously, the invention remedies the significant problems of storing hydrogen, which is technically difficult and dangerous.

According to another advantage, the presentation in liquid form of the composition 13 allows easy manipulation using a simple pumping system that makes it possible to transfer/meter the liquid.

In the case of a use for supplying a fuel cell, the water that is produced by the cell 20 can be reused in the aqueous solution 15 that is necessary to the reaction with the alkaline metal of the colloidal suspension 13.

The device according to the invention can also comprise a heat-exchanger-type heat recovery system, making it possible to generate mechanical power by a Sterling-engine-type device or the equivalent, or else it can be directly transformed into electricity by thermocouple devices.

In addition, the exothermy of the reaction between the alkaline metal and the water can be used in on-board systems that use the device 10 for producing, for example, heating in the passenger spaces of motor vehicles or air-conditioning by an absorption system or else the reheating of fuel cells whose conversion yield is better at a higher temperature.

Finally, according to another advantage, the hydroxide solution that is produced by the reaction between the composition according to the invention and the aqueous solution can be recycled to regenerate the alkaline metal colloidal suspension.

1. A method for producing gaseous hydrogen, comprising using a colloidal suspension that comprises between 2 and 60% of alkaline metal particles suspended in a neutral hydrophobic diluent.

2. The method for producing gaseous hydrogen according to claim 1, wherein the alkaline metal of the colloidal suspension is metallic sodium or lithium.

3. The method for producing gaseous hydrogen according to claim 1, wherein the size of the alkaline metal particles of the colloidal suspension is less than 15 μm.

4. The method for producing gaseous hydrogen according to claim 1, wherein the size of the alkaline metal particles of the colloidal suspension is between 0.1 and 1 μm.

5. The method for producing gaseous hydrogen according to claim 1, wherein the neutral hydrophobic diluent of the colloidal suspension is an organic polymer that is selected from among vegetable oils and mineral oils.

6. The method for producing gaseous hydrogen according to claim 5, wherein the neutral hydrophobic diluent of the colloidal suspension is a silicone oil.

7. The method for producing gaseous hydrogen according to claim 1, wherein the colloidal suspension comprises a dehydrating agent.

8. Process for the production of hydrogen, wherein it consists in bringing a colloidal suspension that comprises between 2 and 60% of alkaline metal particles that are suspended in a neutral hydrophobic diluent into contact with an aqueous solution, so as to produce gaseous hydrogen and an aqueous alkaline hydroxide emulsion.

9. Process for the production of hydrogen according to claim 8, wherein the aqueous solution comprises demineralized purified water and an emulsifying surfactant and/or an organic solvent.

10. Process for the production of hydrogen according to claim 9, wherein the emulsifying surfactant content is between 0.05 and 10%.

11. Hydrogen-generating device (10) that comprises a reservoir (12) for storing a colloidal suspension (13) that comprises alkaline metal particles that are suspended in a neutral hydrophobic diluent, a reservoir (14) for storing an aqueous solution (15), and a mixing chamber (16) into which the composition (13) and the aqueous solution (15) are introduced and from which the gaseous hydrogen can escape.

12. Hydrogen-generating device (10) according to claim 11, wherein it comprises systems for injecting the composition (13) and the aqueous solution (15) into the chamber (16).

13. Hydrogen-generating device (10) according to claim 11, wherein it also comprises a reservoir (18) for recovering hydrophobic oil and the aqueous alkaline hydroxide emulsion that are produced after reaction in the chamber (16).

14. A method of providing hydrogen upon demand, comprising providing a device according to claim 11, for supplying with gaseous hydrogen a fuel cell (20), a thermal motor, or a stationary or mobile station for distribution of hydrogen.

15. The method for producing gaseous hydrogen according to claim 2, wherein the size of the alkaline metal particles of the colloidal suspension is less than 15 μm.

16. The method for producing gaseous hydrogen according to claim 2, wherein the size of the alkaline metal particles of the colloidal suspension is between 0.1 and 1 μm.

17. The method for producing gaseous hydrogen according to claim 3, wherein the size of the alkaline metal particles of the colloidal suspension is between 0.1 and 1 μm.

18. The method for producing gaseous hydrogen according to claim 2, wherein the neutral hydrophobic diluent of the colloidal suspension is an organic polymer that is selected from among vegetable oils and mineral oils.

19. The method for producing gaseous hydrogen according to claim 3, wherein the neutral hydrophobic diluent of the colloidal suspension is an organic polymer that is selected from among vegetable oils and mineral oils.

20. The method for producing gaseous hydrogen according to claim 4, wherein the neutral hydrophobic diluent of the colloidal suspension is an organic polymer that is selected from among vegetable oils and mineral oils.
